(19) United States
(12) Patent Application Publication
(10) Pub. No.: US 2024/0381803 A1
(43) Pub. Date: Nov. 21, 2024

(54) DEVICES, SYSTEMS, AND METHODS FOR AGRICULTURAL GUIDANCE AND NAVIGATION

(71) Applicant: Ag Leader Technology, Ames, IA (US)

(72) Inventor: Nick Wagner, Ames, IA (US)

(21) Appl. No.: 18/665,305

(22) Filed: May 15, 2024

Related U.S. Application Data
(60) Provisional application No. 63/466,560, filed on May 15, 2023.

(51) Int. Cl. A01B 69/04; G05D 1/224; G05D 1/248; G05D 1/648; G05D 101/15; G05D 105/15; G05D 107/20

(52) U.S. Cl. CPC A01B 69/008; G05D 1/2245; G05D 1/248; G05D 1/648; G05D 2101/15; G05D 2105/15; G05D 2107/21

(57) ABSTRACT

Devices, systems, and method for generating agricultural guidance comprising defining a first non-straight path, mapping a second path adjacent to the first path, the second path having less than a threshold amount of crowding of the first non-straight path and less than a threshold amount of gap between the first non-straight path and second path, iteratively mapping subsequent paths path having less than a threshold amount of crowding of an adjacent pass and less than a threshold amount of gap between adjacent paths until a straight path is mapped, and commanding a steering system for traversal of the first non-straight path, second path, and subsequent paths.

### CROSS-REFERENCES & RELATED APPLICATIONS

This application claims the benefit under 35 U.S.C. § 119(e) to U.S. Provisional Application No. 63/466,560, filed May 15, 2023, and entitled “Devices, Systems, and Methods for Agricultural Guidance And Navigation,” the content of which is hereby incorporated herein by reference in its entirety.

### TECHNICAL FIELD

The disclosed technology relates generally to automatic steering, and in particular, to the devices, methods, and design principles allowing for visualization and guidance of automatic steering systems on agricultural tractors and implements.

### BACKGROUND

The disclosure relates to devices, systems, and methods for improvements to guidance and automatic steering systems allowing for the visualization of field paths and more efficient planting, tilling, harvesting, and other agricultural processes over the prior art.

### BRIEF SUMMARY OF THE INVENTION

Disclosed herein are various devices, systems, and methods for adjusting and/or calculating agricultural guidance paths. Various of these implementations correct non-straight paths to be straight paths over second and subsequent paths without deviating more than a defined gap/crowd distance.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In Example 1, an automatic steering system for an agricultural vehicle comprising an agricultural vehicle configured to traverse an area, a processor configured to generate guidance paths from a first non-straight path, wherein subsequent passes are best fit paths adjacent to the first non-straight path and the best fit paths create less than a threshold amount of non-covered area between adjacent paths, and an automatic steering system configured to command the agricultural vehicle to traverse the guidance paths.

Example 2 relates to the system of any of Examples 1 and 3-9, further comprising a display configured to display the guidance paths.

Example 3 relates to the system of any of Examples 1-2 and 4-9, further comprising a GNSS unit.

Example 4 relates to the system of any of Examples 1-3 and 5-9, wherein the processor is configured to best fit paths based on a least square method algorithm.

Example 5 relates to the system of any of Examples 1-4 and 6-9, wherein endpoint of individual guidance paths are user defined.

Example 6 relates to the system of any of Examples 1-5 and 7-9, wherein the best fit paths have less than a threshold amount of crowding of adjacent paths.

Example 7 relates to the system of any of Examples 1-6 and 8-9, wherein the threshold amount of crowding and a threshold amount of non-covered area are user defined.

Example 8 relates to the system of any of Examples 1-7 and 9, wherein the threshold amount of crowding and a threshold amount of non-covered area are defined by a machine learning algorithm.

Example 9 relates to the system of any of Examples 1-8, wherein the guidance paths include heading and position information.

In Example 10, a method for automatically steering an agricultural vehicle comprising driving a non-straight path through a field, generating guidance paths for a portion of the field adjacent to the non-straight path to sequentially straighten subsequent paths through the field, defining a threshold gap distance between subsequent paths, wherein non-covered area between subsequent path is less than the threshold gap distance, and commanding an automatic steering system to drive the agricultural vehicle along the guidance paths.

Example 11 relates to the method of any of Examples 10 and 12-18, wherein the subsequent path are mapped using a least square method.

Example 12 relates to the method of any of Examples 10-11 and 13-18, wherein end points of the non-straight path are user defined.

Example 13 relates to the method of any of Examples 10-12 and 14-18, wherein adjacent paths have less than a threshold amount of crowding.

Example 14 relates to the method of any of Examples 10-13 and 15-18, wherein the threshold amount of crowding is user defined.

Example 15 relates to the method of any of Examples 10-14 and 16-18, wherein the threshold amount of crowding is defined by a machine learning algorithm.

Example 16 relates to the method of any of Examples 10-15 and 17-18, wherein the threshold gap distance is user defined.

Example 17 relates to the method of any of Examples 10-16 and 18, wherein the threshold gap distance is defined by a machine learning algorithm.

Example 18 relates to the method of any of Examples 10-17, wherein the guidance paths include heading and position information.

In Example 19, a method for generating agricultural guidance comprising defining a first non-straight path, mapping a second path adjacent to the first path, the second path having less than a threshold amount of crowding of the first non-straight path and less than a threshold amount of gap between the first non-straight path and second path, iteratively mapping subsequent paths path having less than a threshold amount of crowding of an adjacent pass and less than a threshold amount of gap between adjacent paths until a straight path is mapped, and commanding a steering system for traversal of the first non-straight path, second path, and subsequent paths.

Example 20 relates to the method of Example 19, wherein the first non-straight path is defined by a user.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF DRAWINGS

FIG. 1A is a schematic view of the system implemented on an agricultural vehicle, according to one implementation.

FIG. 1B is a system diagram of the path system, according to one implementation.

FIG. 2 is a schematic diagram of vehicle guidance paths generated based on an initial, manually driven vehicle pass, according to various implementations.

FIG. 3 is a flow diagram of a method for generating agricultural guidance paths, according to various implementations.

### DETAILED DESCRIPTION

The various implementations disclosed or contemplated herein relate to devices, systems, and methods to establish vehicle guidance paths for use by a variety of agricultural vehicles, and particularly agricultural planters.

In certain implementations, these vehicle guidance paths may be used in agricultural operations, such as planting, harvesting, spraying, tilling, and other operations related to row crops, as would be readily appreciated. In these and other implementations, the vehicle guidance paths are used by an automatic, semi-automatic, or assisted steering system for commanding traversal of the guidance paths by an agricultural vehicle.

The disclosed system represents a technological improvement in that it establishes guidance paths for agricultural vehicles for traversing a field and/or performing desired operations. In certain implementations the system establishes guidance paths via a software-integrated display platform such as SteerCommand® or other platform that would be known and appreciated by those of skill in the art.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,334, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. Patent Application 63/524,065, filed Jun. 29, 2023, entitled “Ring Assembly,” U.S. Patent Application 63/525,525, filed Jul. 7, 2023, entitled “Assisted Steering Systems and Associated Devices and Methods for Agricultural Vehicles,” U.S. Patent Application 63/593,837, filed Oct. 27, 2023, entitled “Agricultural Implement Position Sensor and Related Devices, Systems, and Methods,” U.S. Patent Application 63/603,969, filed Nov. 29, 2023, entitled “Devices, Systems and Methods for Guidance Line Shifting,” U.S. Patent Application 63/607,227, filed Dec. 7, 2023, entitled “Header Height Control Devices, Systems and Methods,” U.S. Patent Application 63/609,758, filed Dec. 13, 2023, entitled “Magnetic Stripper/Deck Plate Sensing System,” U.S. Patent Application 63/646,038, filed May 13, 2024, entitled “Seed Tube Camera and Related Devices, Systems, and Methods,” U.S. Patent Application 63/626,744, filed Jan. 30, 2024, entitled “Grain Cart Unloading Sensor and Unload Control,” and U.S. Patent Application 63/648,068, filed May 13, 2024, entitled “Seed Tube Camera and Related Devices, Systems, and Methods,” each of which is incorporated herein by reference.

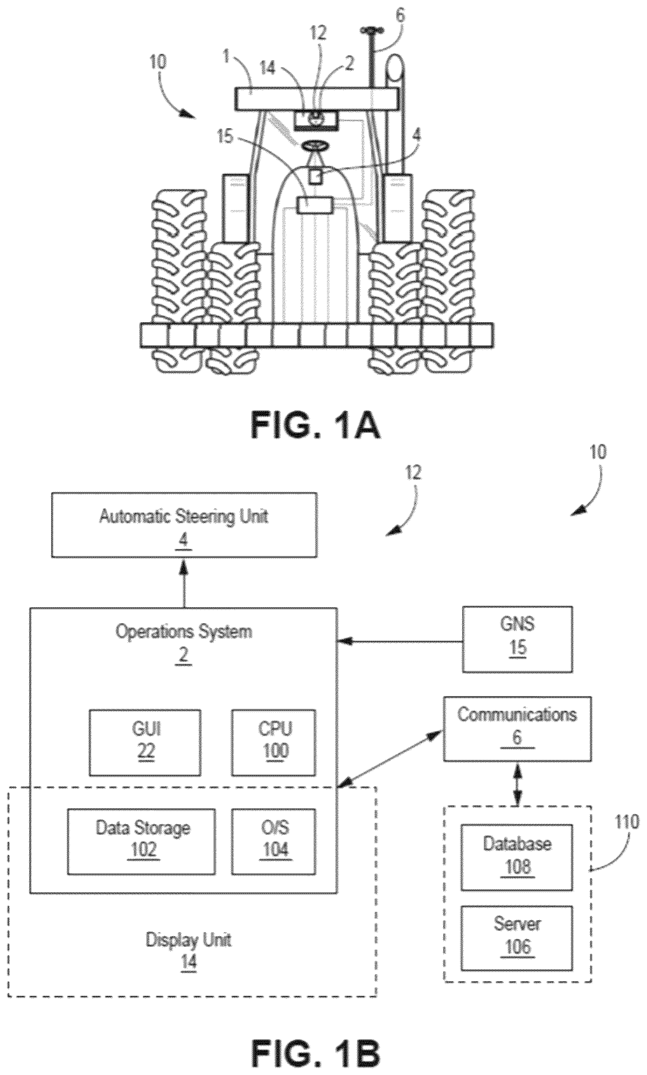

Turning to the drawings in greater detail, FIGS. 1A-1B depict exemplary implementations of the various visualization and guidance system 10 components fitted to an agricultural vehicle 1. In various implementations, the agricultural vehicle 1 may be a tractor 1, optionally having an implement such as a planter, as would be understood. It is understood that a variety of vehicles 1 and implements can be utilized in various implementations. It is further understood that the components depicted in FIGS. 1A-1B are optional, and can be utilized or omitted in the various claimed implementations, and that certain additional components may be required to effectuate the various processes and systems described herein. Such additional components may include hardware, software, firmware, and other electronic components that would be known and appreciated by those of skill in the art.

As shown in FIG. 1A, the visualization and guidance system 10 has an operations system 2 that comprises or is configured to be operationally integrated with a steering unit 4, such as SteerCommand®, and an optional communications component 6. The system 10 is operationally integrated with at least one in-cab display 14, such as an InCommand® display 14, or other suitable display 14 understood in the art.

It is appreciated that certain of these displays 14 feature touchscreens, while others are equipped with necessary components for interaction with the various prompts and adjustments discussed herein, such as via a keyboard or other interface.

In various implementations, the system is also operationally integrated with a GNSS or GPS unit 15, such as a GPS 7500, such that the system 10 is configured to input positional data for use in defining boundaries, locating the tractor 1 and plotting guidance and the like, as would be readily appreciated from the present disclosure.

As shown in FIG. 1B, in various implementations, the operations system 2 is optionally in operational communication with the automatic steering unit 4 or controller 4, the communications component 6, and/or GNSS 15. In certain of these implementations, the operations system 2 is housed in the display 14, though the various components described herein can be housed elsewhere, as would be readily appreciated.

As shown in FIG. 1B, the operations system 2 further has one or more optional processing and computing components, such as a CPU/processor 100, data storage 102, operating system 104, and other computing components necessary for implementing the various technologies disclosed herein. It is appreciated that the various optional system components are in operational communication with one another via wired or wireless connections and are configured to perform the processes and execute the commands described herein.

In certain implementations, like that of FIG. 1B, the communications component 6 is configured for the sending and receiving of data for cloud 110 storage and processing, such as to a remote server 106, database 108, and/or other cloud computing components readily understood in the art. Such connections by the communications component 6 can be made wirelessly via understood internet and/or cellular technologies such as Bluetooth, WiFi, LTE, 3G, 4G, or 5G connections and the like. It is understood that in certain implementations, the communications component 6 and/or cloud 110 components comprise encryption or other data privacy components such as hardware, software, and/or firmware security aspects. In various implementations, the operator or enterprise manager or other third parties are able to receive notifications such as adjustment prompts and confirmation screens on their mobile devices, and in certain implementations can review the plotted guidance paths and make adjustments via their mobile phones.

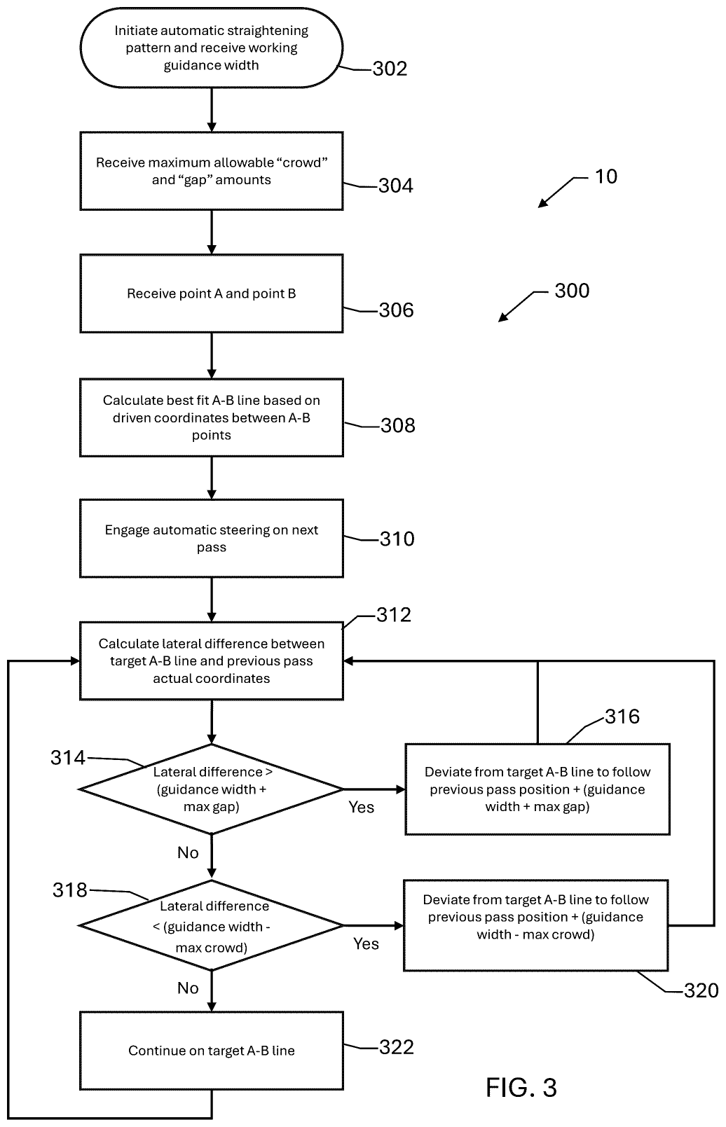

From the foregoing exemplary implementations, it is understood that in use, various implementations of the guidance path system 10 comprises a variety of optional steps and sub-steps automating path plotting and execution. FIG. 3 depicts an exemplary process chart showing various optional aspects of the features and implementations described an illustrated below. It is understood that while FIG. 3 depicts one exemplary process 200 implementation of the path system 12, many other configurations are possible. Further, while each of the steps and sub-steps are described herein in an order, the various steps and sub-steps may be performed in alternate orders or simultaneously with one another, and each of the various steps is optional and can be omitted. Further, it is readily appreciated that the various steps may be iterated upon, such as when moving from one field map to the next, transmitting and receiving information, and plotting successive paths.

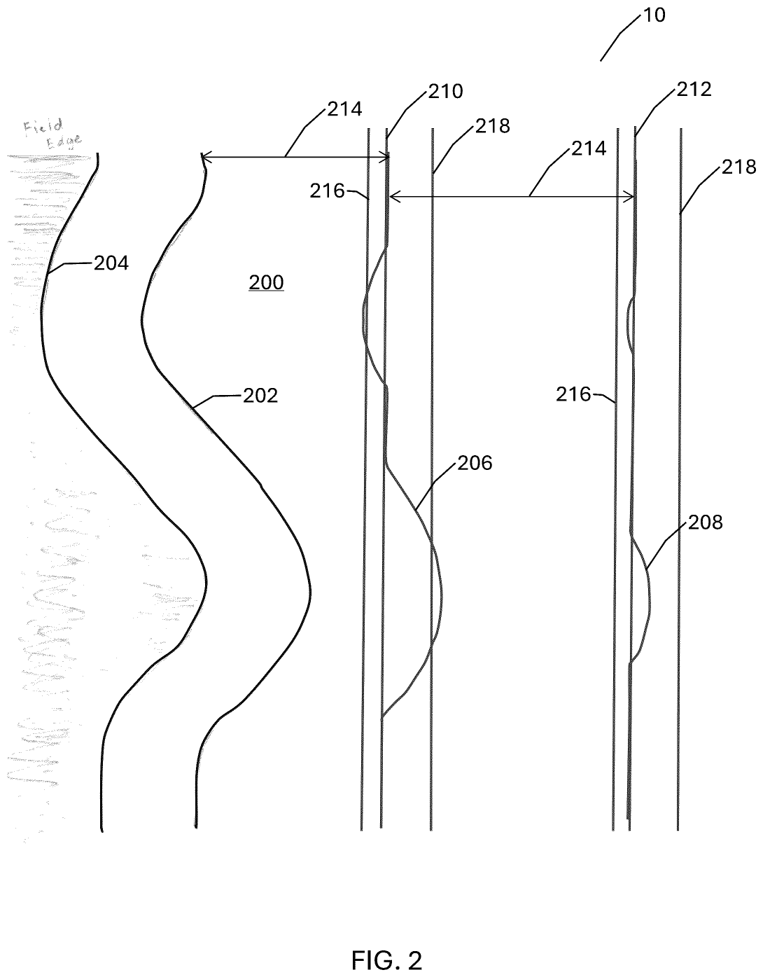

Various of the optional steps and sub-steps described in the guidance path system 10 process of FIGS. 2-3, can be performed manually, via automation or calculation, or can be retrieved or commanded remotely, as would be readily understood. Further, the various optional steps and sub-steps described herein may be performed contemporaneously or sequentially in any order and in certain implementations iteratively, as would be readily appreciated.

In various implementations, the guidance path system 10 is configured to generate a guidance pattern of multiple guidance paths that automatically straightens the guidance paths after an initially crooked pass. The terms “crooked,” “non-straight,” and “nonlinear” are all used herein to describe a vehicle pass that deviates from a straight line. In various cases a, manually driven pass may diverge from a straight line. After this initial, crooked pass, the system may automatically generate guidance (e.g., in the form of guidance paths) for automatic or assisted steering to straighten the line over the course of one or more subsequent passes. In various implementations the system is configured to further minimize the unplanted/uncovered area while correcting the nonlinear pass.

As an example, the first planting pass that an agricultural vehicle makes along a field boundary like a fence line or road ditch may vary from a straight line due to the contour of the boundary, see the first line 204 in FIG. 2. After driving the first pass, the system 10 may be engaged to calculate and drive a best fit straight-line pattern that includes a series of best fit straight line guidance paths. In various implementations the pattern generally follows the contour of the first pass, but since the system is working towards a straight pass, the guidance pattern crowds and/or gaps subsequent passes until the straight line has been achieved, see lines 206, 208 in FIG. 2.

In various implementations, the guidance system 10 is configured to calculate the best fit straight line based on the actual coordinates of the vehicle during the non-straight pass. For example, the system 10 may use the least square method or another suitable algorithm to fit a straight line to the coordinates of the previous pass. In various implementations the system 10 is configured to determine the best fit line based on end points that the operator sets (e.g., A-B points) at the beginning and end of the previous pass. In such cases the best fit straight line is sometimes referred to herein as an “A-B line” or “straight A-B line.”

In various implementations, the amount of allowable crowd and/or gap per pass can be entered by the user (e.g., via a graphical user interface) at the time of selecting the guidance pattern. In various cases an operator may also enter a preferred guidance width, indicating the spacing to be used between adjacent passes. As one example, when used for a 12 row planting with 30 inch spacing, the operator may enter a 360 inch guidance width, a maximum crowding (i.e., crowding width) of 8 inches, and a maximum gap (i.e., gap width) of 3 inches. Various alternative spacing, sizes, and selections are possible and would be understood by those of skill in the art.

The various systems, devices, and methods described herein relate to technologies for the generation of guidance paths for use in various agricultural applications, and may be referred to herein as a guidance system 10, though the various methods and devices and other technical improvements disclosed herein are also of course contemplated.

The disclosed system 10 can generally be utilized to generate paths for use by agricultural vehicles as the vehicle 1 traverses a field. It is understood that as discussed herein, a guidance path 10 can relate to the route to be taken by the center of an agricultural implement so as to plot a path through a field or elsewhere to conduct an agricultural operation, as would be readily appreciated by those familiar with the art.

In these implementations, the vehicle guidance paths may include heading and position information, such as GPS coordinates indicating the location(s) where the tractor and/or other vehicle should be driven for proper placement within a field, such as between the crop rows, as has been previously described. It would be appreciated that various agricultural vehicles include a GPS unit for determining the position of the vehicle within a field at any given time. This GPS unit may work in conjunction with the system, and optionally an automatic steering system, to negotiate the tractor or other vehicle along the guidance paths, as would be appreciated.

As would be understood, the guidance paths are used for agricultural operations including planting, spraying, and harvesting, among others. In various known planting or other agricultural systems, as discussed in many of the references incorporated herein, vehicle guidance paths are plotted in advance of operations to set forth the most efficient, cost effective, and/or yield maximizing route for the tractor or other vehicle to take through the field. Additionally, or alternatively, the generated guidance paths may be used for on-the-go determinations of vehicle paths and navigation.

FIG. 2 is a schematic diagram of a field 200 illustrating a crooked pass 202 that generally follows the contour of a boundary 204 of the field 200. The diagram further illustrates a first guidance path 206 and a second guidance path 208 automatically determined by the guidance system 10 according to implementations of the disclosed technology. The calculated guidance paths 206, 208 are centered along respective straight A-B lines 210, 212, which are spaced apart from the initial pass 202 and from each other by a guidance width 214. Maximum gap lines 216 illustrate the width of the maximum gap, and maximum crowding lines 218 illustrate the width of the maximum crowding, each with respect to the A-B lines. It should be appreciated that FIG. 2 is a schematic diagram illustrating various concepts of the disclosed technology and is not drawn to scale.

In one specific example, the system 10 is for use with a 12 row planting having 30″ spacing (360″ guidance width 214), a user selected 8″ maximum crowding 218 and a user selected 3″ maximum gap 216 spacing per pass. Various alternative spacing, sizes, and selections are possible and would be understood by those of skill in the art.

In the example illustrated in FIG. 2, the guidance width 214 is 360″ and the system 10 is configured to generate the guidance pattern to automatically straighten vehicle passes by crowding the subsequent guidance paths 206, 208 up to the maximum crowding width 218 of 8 inches where required, while only allowing gaps up to the maximum gap width 216 of 3 inches. Accordingly, in this example, the system 10 is configured to generate a guidance pattern that can make up to 11 inches of lateral correction per pass until all error has been eliminated and subsequent passes are straight. The number of passes needed to fully straighten the vehicle pass depends on the amount of error in the previously driven pass at the time of engaging the pattern, as well as the user specified amounts of allowable row crowding and gapping.

In this example, the first pass 202 is manually driven and follows the field edge 204. At the end of the pass 202 the system 10 automatically calculated a best fit A-B line based on the coordinates of the pass 202. On the next parallel pass the system 10 compares the target A-B line 210 with the lateral position from the previous pass 202. If the compared lateral position from the previous pass is greater than the guidance width plus the max gap setting (360+3), then the system 10 will follow the previous pass position plus 363″ (guidance width+max gap). Conversely, if the compared lateral position is less than the guidance width minus the max crowding setting (360−8), then the system 10 will follow the previous pass position plus 352″ (guidance width−max crowding.) Finally, if the compared lateral position from the previous pass is less than the guidance width plus max gap (360+3) and compared lateral position is greater than the guidance width minus max crowding, (360−8) the system 10 will follow the target A-B line.

In various implementations, the system can be engaged automatically, manually, or semiautomatically. For example, the system may automatically be engaged after turning around on the first pass the pattern. The system 10 then calculates a best fit A-B line from the lateral error based on the previous (1st) pass in the field.

In various alternative implementations, the system 10 is engaged manually. In these and other implementations, the user decides when to activate the pattern. When engaged the pattern will calculate a best fit A-B line from the lateral error based on the previous pass (this could be multiple passes later in the field).

In further implementations, the user decides when and where to set A-B points on a given pass. Lateral error contained between the points will not be used to calculate a best fit line since actual A-B points were set.

In further implementations, the system 10 may be engaged to correct error when a path is determined to have more than a threshold amount of deviation from a straight line. The threshold may be user entered, determined by machine learning, or otherwise entered.

FIG. 3 is a flow diagram illustrating a method 300 for the guidance system 10 to generate guidance paths according to various implementations. The example process 300 begins with initiating an automatic straightening pattern and receiving a working guidance width (302). For example, the user may select automatic straightening pattern from a menu of options in the guidance system interface. The system 10 then initiates use of the automatic straightening pattern in response. In various cases the system further provides a screen interface or other input method for the user to enter the working guidance width, which the system receives and stores in memory.

The method 300 also includes the system 10 receiving the maximum allowable crowd amount and the maximum allowable gap amount (304). In various cases the user may enter the maximum crowd and gap amounts on an interface screen following entry of the working guidance width. It should be appreciated that the system may request and/or receive the working guidance width, maximum allowable gap amount, and maximum crowd amount together and/or separately in different orders and at different times in various implementations.

The method 300 further includes the guidance system receiving and storing guidance points A and B (306). For example, in some cases the user drives the vehicle to a starting location and sets point A via the interface and then manually drives along an intended path to a second location and sets point B. The guidance system 10 receives points A and B and calculates a best fit A-B line for a subsequent pass based on those end points (308). In various implementations the system alternatively calculates a best fit straight line based on a series of coordinates recorded during and/or corresponding to a previous pass. In various cases the system may enable the user to select (e.g., via a graphical interface) whether to determine the best fit A-B line based on manually set end points, driven coordinates of a previous pass, or another reference.

Once automatic steering is engaged (310) (e.g., by the user on the next pass), the guidance system initiates automatic steering with an automatic straightening pattern on the next pass. As the vehicle drives, the guidance system 10 repeatedly calculates the lateral difference between the target A-B line and the actual coordinates of the previous pass (312). In various implementations, the system then compares the lateral difference to the working guidance width and the maximum gap and crowd widths. For example, in various cases the system determines whether the lateral difference is greater than the sum of the guidance width and the max gap value (314). In various cases the method 300 also includes the system 10 determining whether the lateral difference is less than the difference of the guidance width and the max crowding value (318).

As previously discussed, in various implementations the guidance system generates the guidance path so that it deviates from the target A-B line under certain conditions. In the example of FIG. 3, when the system determines (314) that the lateral difference is greater than the combined guidance width and max gap, the guidance system modifies the guidance path to deviate from the target A-B line and instead follow the previous pass contour at a lateral distance equal to the sum of the guidance width and the maximum gap width (316). As another example, when the system determines (314) that the lateral difference is less than the combined guidance width and max gap, the guidance system determines whether the lateral difference is less than the difference of the guidance width and the max crowding value (318). If yes, the system modifies the guidance path to deviate from the target A-B line in order to follow the previous pass contour at a lateral distance equal to the guidance width less the maximum crowding width (320).

After deviating from the target A-B line at steps 316 and/or 320, the system 10 returns to calculating the difference between the target A-B line and the previous pass coordinates at step 312. The system likewise returns to step 312 if the guidance path has continued on target A-B line without deviation. The system then once again evaluates the lateral distance from the previous pass, and deviates from the target A-B line when the lateral difference is greater than or less than the guidance width plus the max gap or minus the max crowd. Otherwise the guidance path continues along the target A-B line (322).

The repeated process 300 enables the guidance system to more smoothly transition the guidance path between a potentially crooked previous pass and a more desirable straight pass by incrementally correcting the deviations from a straight guidance path over a number of passes. The guidance system further enables the user to control the rate of correction by adjusting the maximum gap width and/or the maximum crowding width.

Although the disclosure has been described with reference to preferred embodiments, persons skilled in the art will recognize that changes may be made in form and detail without departing from the spirit and scope of the disclosed apparatus, systems and methods.

What is claimed is:

1. An automatic steering system for an agricultural vehicle comprising:
(a) an agricultural vehicle configured to traverse an area;
(b) a processor configured to generate guidance paths from a first non-straight path, wherein subsequent passes are best fit paths adjacent to the first non-straight path and the best fit paths create less than a threshold amount of non-covered area between adjacent paths; and
(c) an automatic steering system configured to command the agricultural vehicle to traverse the guidance paths.

2. The system of claim 1, further comprising a display configured to display the guidance paths.

3. The system of claim 1, further comprising a GNSS unit.

4. The system of claim 1, wherein the processor is configured to best fit paths based on a least square method algorithm.

5. The system of claim 1, wherein endpoint of individual guidance paths are user defined.

6. The system of claim 1, wherein the best fit paths have less than a threshold amount of crowding of adjacent paths.

7. The system of claim 6, wherein the threshold amount of crowding and a threshold amount of non-covered area are user defined.

8. The system of claim 6, wherein the threshold amount of crowding and a threshold amount of non-covered area are defined by a machine learning algorithm.

9. The system of claim 1, wherein the guidance paths include heading and position information.

10. A method for automatically steering an agricultural vehicle comprising:
driving a non-straight path through a field;
generating guidance paths for a portion of the field adjacent to the non-straight path to sequentially straighten subsequent paths through the field,
defining a threshold gap distance between subsequent paths, wherein non-covered area between subsequent path is less than the threshold gap distance; and
commanding an automatic steering system to drive the agricultural vehicle along the guidance paths.

11. The method of claim 10, wherein the subsequent path are mapped using a least square method.

12. The method of claim 10, wherein end points of the non-straight path are user defined.

13. The method of claim 10, wherein adjacent paths have less than a threshold amount of crowding.

14. The method of claim 13, wherein the threshold amount of crowding is user defined.

15. The method of claim 13, wherein the threshold amount of crowding is defined by a machine learning algorithm.

16. The method of claim 10, wherein the threshold gap distance is user defined.

17. The method of claim 16, wherein the threshold gap distance is defined by a machine learning algorithm.

18. The method of claim 10, wherein the guidance paths include heading and position information.

19. A method for generating agricultural guidance comprising:
defining a first non-straight path;
mapping a second path adjacent to the first path, the second path having less than a threshold amount of crowding of the first non-straight path and less than a threshold amount of gap between the first non-straight path and second path;
iteratively mapping subsequent paths path having less than a threshold amount of crowding of an adjacent pass and less than a threshold amount of gap between adjacent paths until a straight path is mapped; and
commanding a steering system for traversal of the first non-straight path, second path, and subsequent paths.

20. The method of claim 19, wherein the first non-straight path is defined by a user.
